(19) United States
(12) Patent Application Publication
(10) Pub. No.: US 2020/0309968 A1
(43) Pub. Date: Oct. 1, 2020

(54) STRUCTURE FOR MOUNTING PHOTOMULTIPLIER TUBE TO SCINTILLATOR

(71) Applicants: Jun Suhk SUH, Daegu (KR); Hyeun Suk PARK, Daegu (KR); JSTECHWIN Co., Ltd., Daegu (KR)

(72) Inventors: Jun Suhk SUH, Daegu (KR); Hyeun Suk PARK, Daegu (KR)

(73) Assignees: JSTECHWIN Co., Ltd., Daegu (KR); Jun Suhk SUH, Daegu (KR); Hyeun Suk PARK, Daegu (KR)

(21) Appl. No.: 16/089,546

(22) PCT Filed: Mar. 9, 2017
(86) PCT No.: PCT/KR2017/002598

§ 371 Date: Sep. 28, 2018

(30) Foreign Application Priority Data
Mar. 28, 2016 (KR) 10-2016-0036772

(51) Int. Cl. G01T 1/20

(52) U.S. Cl. CPC G01T 1/20185

(57) ABSTRACT

The present invention is directed to a structure for mounting a photomultiplier tube to a scintillator comprising fixing means for fixing a PMT for detecting visible ray to a scintillator panel (30) generating the visible ray by radiation collision, wherein said fixing means are formed as a clamp (20) with a holder (25) on a front part (21), which makes the PMT (10) contact with the scintillator panel, and wherein securing means for securing said clamp (20) to the upper and lower surfaces of the scintillator panel (30) is included. Accordingly, it is possible to conveniently mount the PMT without any damage to the scintillator panel, and thus, the optical loss due to the cracks within the scintillator panel occurring when mounting the PMT of the prior art and the screws inserted in the scintillator panel are eliminated, so that the measurement of radiation can be more accurately performed.

### FIELD OF THE INVENTION

The present invention relates to a structure for mounting a photomultiplier tube to a scintillator, and particularly to an improved structure for mounting the photomultiplier tube to the scintillator panel without any damage to the scintillator panel.

### BACKGROUND OF THE INVENTION

Generally, a radiation detecting device comprises a photo-multiplier tube, which multiplies flash light generated when high energy particles of radiation radiated from an object to be examined collide scintillator, and converts the flash light generated when the radiation radiated from the object to be examined collides the scintillator to an electric signal, to thereby measure the number and the level of the radiation.

In a broad sense, the radiation comprises not only ionized radiation, such as an X-ray that may be harmful to a human body by causing ionization, radioisotope, cosmic ray, but also electromagnetic wave including light or X-ray, alpha-ray, beta-ray and gamma-ray generated from radioisotope. Here, the ionization means that an outer electron is separated from a portion of element constituting material, to thereby produce ions, wherein these ions may deform organization, and thus, they may cause various changes in a body.

Recently, as the use of radiation technology is enlarged, the environmental pollution due to radioactive substance, the radiation hazard caused by the latter and the impairment to a human body due to radiation exposure are an important social issue.

Particularly, the accident in the nuclear power plant occurred at Fukushima in Japan near Korea and it is known that the radioactive contamination due to the accident is at serious level. However, under the circumstance that the volume of export and import between Korea and Japan is very large and that it is difficult to grasp real condition about the contamination of marine products from shore of the Korea due to the radioactive contamination of shore of the Japan. Anxiety about radioactive contamination of imported goods, including fish caught on the Pacific coast where Japanese and Japanese currents flow, is increasing.

For this reason, in entry process of men or customs entry process of imported goods that are suspected for exposure to radioactivity, the necessity for thorough examination of radiation level increases. Accordingly, a radiation detecting device capable of exactly measuring a level of radiation is required.

As an example of the radiation measurement using the scintillator and PMT, KR 10-1248760 (Mar. 18, 2013) discloses an optical fiber phantom dosimeter and a measuring method using the same, wherein plastic or glass optical fiber, which is capable of transmitting light in the range of visible ray emitted from the scintillator, is cylindrical optical fiber or square optical fiber and wherein a photo detector comprises photodiode, Avalanche photodiode, a photo-multiplier tube (PMT), a position sensitive photomultiplier tube (PS-PMT) and charged couple device, CCD, which can measure optical signal transmitted through said optical fiber.

As schematically shown in FIGS. 1 and 2, the conventional radiation detector comprises a scintillator panel (1) covered with a reflective film (2) and PMTs (6) on either side of the scintillator panel (1), so that visible light generated from the collision between the radiation and the scintillator is measured by the PMT. The PMT is mounted with a base (7) converting detected lights to electric signals.

The PMT (6) is inserted into a cylindrical holder (5) which is formed on a fixing plate (3) and the fixing plate (3) is fixed to the scintillator (1) using screws (4), so that the PMT is mounted to the scintillator.

As described above, the fixing plate is fixed to the scintillator using the screws (4) in order to connect the PMT to the scintillator, so that cracks occur in the scintillator as shown in FIGS. 3A and 3B in the process of the intrusion of the screws into the scintillator. Also, holes are formed within the scintillator due to the intrusion of the screws, and thus, optical loss occurs because the light generated by radiation in the scintillator cannot be transmitted to the PMT due to interfaces between the cracks and the screw holes. As a result, the light generated by the radiation cannot be precisely measured and errors in measuring the radiation are enlarged, because the fixing plate mounted with the PMT is fixed to the scintillator using the screws.

### PRIOR ART

D1: KR patent 10-1248760 (Date of Registration: Mar. 18, 2013)

### The Problem to be Solved

In order to solve the above-described problem of the conventional structure for the PMT mounting, the present invention is to provide means for mounting the PMT to the scintillator enabling prevention of damage to the scintillator, wherein the structure for mounting the photomultiplier tube to the scintillator is improved in order to allow the light generated in the scintillator to be measured by the photomultiplier tube without any optical loss.

### SUMMARY OF THE INVENTION

In order to attain the object of the present invention, a structure for mounting a photomultiplier tube to a scintillator comprises fixing means for fixing a PMT for detecting visible ray to a scintillator panel generating the visible ray by radiation collision, wherein said fixing means are formed as a clamp with a holder on a front part, which makes the PMT contact with the scintillator panel, and wherein securing means for securing said clamp to upper and lower surfaces of the scintillator panel is included.

Said clamp is in the form of “[”, which comprises upper and lower fixing parts placed on the upper and lower surfaces of the scintillator panel, respectively.

Said securing means may comprise a tape securing the upper and lower fixing parts of the clamp to the upper and lower surfaces of the scintillator panel.

Said holder is formed as a cylindrical member into which said PMT is inserted.

It is preferred that optical grease is provided on an interface between the scintillator panel and the PMT inserted into the holder of the clamp.

### Advantages of the Invention

According to the present invention, the photomultiplier is mounted to the scintillator panel by means of the clamp which is fitted to the upper and lower surfaces of the scintillator panel and fixed by taping, so that the PMT can be conveniently fixed without causing any damage to the scintillator panel. Accordingly, it is possible to eliminate the optical loss due to the cracks within the scintillator panel occurring when mounting the PMT of the prior art and the screws inserted in the scintillator panel, so that the measurement of radiation can be more accurately performed.

### BRIEF DESCRIPTION OF THE DRAWINGS

FIG. 1 is a schematic perspective view showing a structure for mounting the PMT to the scintillator in the prior art.

FIG. 2 is a schematic cross-sectional view of FIG. 1.

FIG. 3A is a photograph showing the damage to the scintillator panel by the PMT mounting structure of FIG. 1.

FIG. 3B is a side view showing a configuration formed with the holes by the screws inserted into the scintillator panel in the PMT mounting structure of FIG. 1.

FIG. 4 is an exploded view of a structure for mounting the PMT to the scintillator panel according to the present invention.

FIG. 5 is a perspective view showing that the PMT mounting structure of FIG. 4 is assembled.

FIG. 6 is a schematic cross-sectional view of FIG. 5.

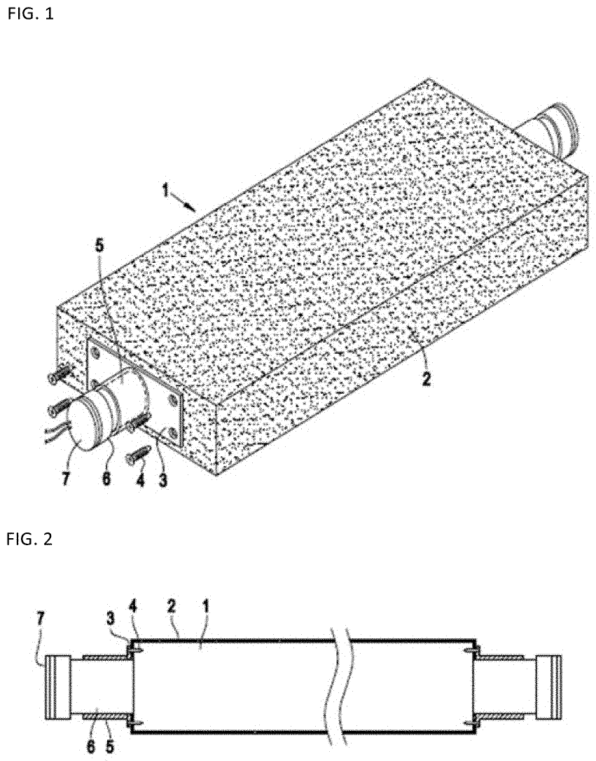

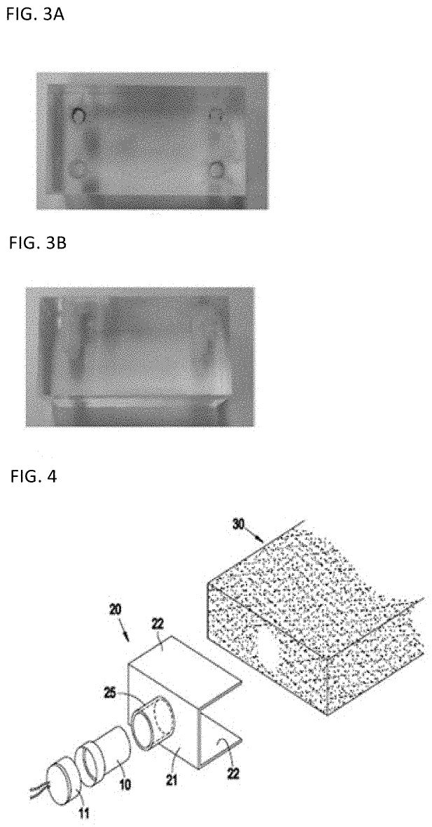

### DETAILED DESCRIPTION OF THE INVENTION

Herein-below, an embodiment of the present invention will be described with reference to the drawings.

Referring to FIG. 4, a structure for mounting a photomultiplier tube to a scintillator according to the present invention comprises: a PMT (10); a clamp (20) serving as fixing means wherein a holder (25) of a cylindrical member is integrally formed on a front part (22), wherein a hole is formed through the holder on the front part (21) and wherein upper and lower fixing parts (22) are spaced apart in the form of “[”; and a scintillator panel (30) fitted between the upper and the lower fixing parts (22) of the clamp (20). In the embodiment shown in the drawing, the holder (25) is formed as a cylindrical member, but it could be formed to have a rectangular shape. As an alternative, the fixing part may be provided on either lateral side as well as the upper and lower parts.

In some cases, a base (11) is integrally coupled to a rear part of the PMT (10) to thereby convert the light sensed in the PMT (10) to electric signal. The coupling configuration between the PMT and the base is well known in the art and the detailed description thereto is omitted.

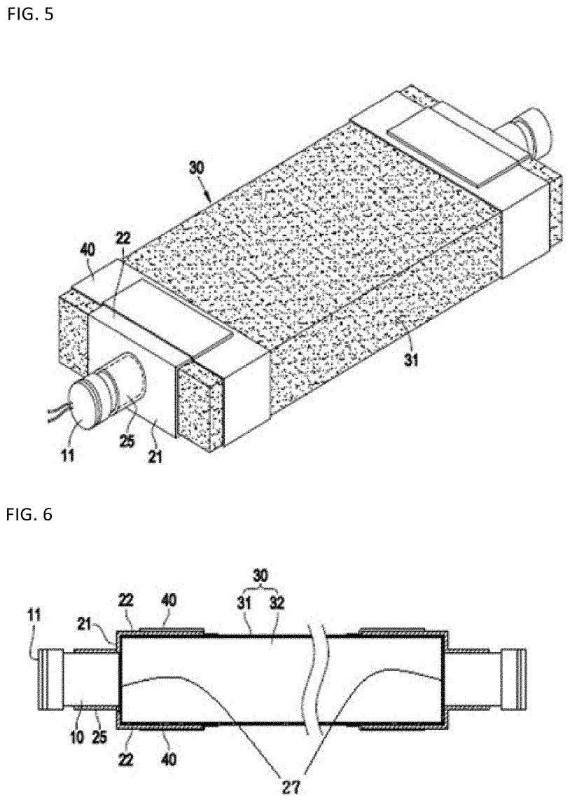

Referring to FIGS. 5 and 6, the clamp (20) is mounted to the scintillator panel (30) with the PMT (10) inserted into the holder (25) of the clamp (20) of FIG. 4. The clamp (20) is mounted to the side of the scintillator panel (30) with the upper and lower fixing parts (22) placed on the upper and lower surfaces of the scintillator panel (30), respectively.

The scintillator panel (30) is such that an entire outer surface of the scintillator (32) is covered with a reflection film (31), so that visible light, which is generated by collision of radiation with the scintillator, does not leak outside and reflects within the scintillator panel, to thereby allow the PMT mounted to either side of the scintillator panel by the clamp to detect the visible light.

In order to stably fix the clamp (30) to the scintillator panel (30), tape (40) serving as securing means wraps around the upper and lower fixing parts (22) of the clamp (20) mounted to the scintillator panel, so that the upper and lower fixing parts (22) of the clamp (20) are secured to the scintillator panel.

It is readily understood by one of ordinary skill in the art that a span between the upper and lower fixing parts (22) and a width thereof may be changed according to a width and a thickness of the scintillator panel (30) to which the PMT is mounted, so as to mount the PMT stably.

An end of the PMT (10) press-inserted into the holder (25), which is formed as a cylindrical member at the front part (21) of the clamp (20), is arranged opposite to the side of the scintillator panel through a hole communicating with an interior of the holder on the part side of the clamp, and optical grease (27) is provided between the PMT and the scintillator panel to contact them. If the end face of the PMT (10) is arranged to directly contact the side of the scintillator, light reflects on the interface between the PMT (10) and the scintillator, so that it leads to optical loss. If the optical grease (27) is provided on the interface between the scintillator panel and the PMT, the effect like the interface removal is obtained. Accordingly, the optical loss is prevented.

Although the tape is exemplified used as the means for securing the clamp to the scintillator panel in the above-described embodiment, adhesive may be used.

### INDUSTRIAL APPLICABILITY

The present invention can be used for mounting the PMT without any optical loss, wherein the PMT measures the visible ray generated from the collision of the radiation with the scintillator panel to thereby estimate the radiation level and the strength thereof.

[Brief Description for the Reference Numerals]

| | |
|---|---|
| 10: PMT | 11: base |
| 20: clamp | 21: front part |
| 22: fixing part | 25: holder |
| 30: scintillator panel | 40: tape |

1. A structure for mounting a PMT (10) to a scintillator, comprising fixing means which fixes the PMT (10) for detecting visible ray to a scintillator panel (30) generating said visible lay by radiation collision,
wherein said fixing means comprises:
a holder (25) in the form of a cylindrical member, which is integrally formed on a front part (21) so as to make the PMT contact with the scintillator and into which the PMT (10) is press-inserted; and
a clamp (20) in the form of “[”, which includes upper and lower fixing parts (22) placed on the upper and lower surfaces of the scintillator panel (30), respectively; and
wherein a tape (40) securing the upper and lower fixing parts (22) of the clamp (20) to the upper and lower surfaces of the scintillator panel (30) is included as securing means for securing said clamp (20) to the upper and lower surfaces of the scintillator panel (30).
